(19) United States
(12) Patent Application Publication
(10) Pub. No.: US 2014/0245874 A1
(43) Pub. Date: Sep. 4, 2014

(54) PAIR OF SAW BLADES

(71) Applicant: TWINBLADE TECHNOLOGIES HOLDING SWEDEN AB, Kalmar (SE)

(72) Inventor: Hans ERICSSON, Farjstaden (SE)

(73) Assignee: TWINBLADE TECHNOLOGIES HOLDING SWEDEN AB, Kalmar (SE)

(21) Appl. No.: 14/276,608

(22) Filed: May 13, 2014

Related U.S. Application Data
(63) Continuation of application No. 13/534,331, filed on Jun. 27, 2012, now abandoned.
Application No. 13/534,331 is a continuation of application No. 12/312,403, filed on Jun. 2, 2009, now abandoned.

(30) Foreign Application Priority Data
Nov. 9, 2006 (SE) 0602393-1

(51) Int. Cl. B23D 61/02

(52) U.S. Cl. CPC B23D 61/02
USPC 83/835

(57) ABSTRACT

The invention concerns a pair of saw blades, including a first blade and a second blade, which are arranged to rotate around the same rotational axis in opposite directions. Each of the blades has its own blade body and peripheral cutting elements, wherein the blade body of the first blade has a front side, which is turned towards a back side of the blade body of the second saw blade, and wherein the cutting elements form overhangs protruding from said front or back side. Said front and/or back side have/has a circumferential ridge, which is arranged peripherally inside of the cutting elements and to slide over a corresponding part or a corresponding ridge on the opposite back side and/or front side, wherein the ridge/ridges is/are made in one piece with the blade body in question and serves/serve as a spacer means to prevent the cutting elements with their overhangs to hit each other during rotation of the blades.

The present invention is a continuation of U.S. patent application Ser. No. 12/312,403 filed Jun. 2, 2009, which in turn claims priority on PCT Application Serial No. PCT/SE2007/000994 filed Nov. 9, 2007, which in turn claims priority on Swedish Application Serial No. 0602393-1 filed Nov. 9, 2006.

### TECHNICAL FIELD

The present invention concerns a pair of saw blades, including a first blade, which is arranged to rotate in a first direction around a rotational axis, and a second blade, which is arranged to rotate around the same rotational axis in a second direction opposite to the first direction, wherein each of the blades has its own blade body and cutting elements along the periphery of each blade body, the cutting elements being arranged to run close to and in parallel with each other during rotation, and wherein the blade body of the first saw blade has a front side, which is intended to be turned towards a back side of the blade body of the second saw blade.

### STATE OF THE ART

From the international patent application WO02/092298, it is known to arrange a spacer means between two cooperating saw blades in order to prevent the cutting elements from hitting each other. In this known solution, the spacer means consists of either radially extended cutting elements on one of the blades, which slide on the blade body of the second, opposing blade, or of a spacer ring or a surface coating on either blade, which is also arranged to slide on the blade body of the opposing saw blade.

A disadvantage with the extended cutting elements according to the international patent application is that there are small intervals between the individual cutting elements, which during operation entails both noise and a risk of saw dust and the like entering in between the saw blades, thus jeopardizing operation. A disadvantage with the other spacer means is above all a tendency to fall off or to quickly be worn down during operation, a tendency further promoted by high temperatures occurring during sawing.

In addition, in the known solution with the extended cutting elements grinding of the cutting elements causes problems. This is due to the fact that the opposing blade in such a solution is forced forced to have cutting elements that do not protrude from the blade body in question, and for that reason during grinding these of these cutting elements one has to count on problems with grinding wheels being clogged by the sheet metal of the blade body, said sheet metal being inevitably affected by the grinding.

### OBJECT OF THE INVENTION

Against this background, the object of the present invention is to obviate the disadvantages of the known solution and to provide a pair of saw blades that works rather quiet and operates more safely and in addition is easier to produce.

### SUMMARY OF THE INVENTION

According to the invention, this object is achieved by a pair of saw blades according to the preamble in that the cutting elements on the blade body of the first blade protrude with a first overhang from said front side in a direction towards the second blade, in that the cutting elements on the blade body of the second blade protrude with a second overhang from said back side in a direction towards the first blade, and in that said front side and/or back side have/has a circumferential ridge, which is arranged peripherally inside of the cutting elements and to slide over a corresponding part or a corresponding ridge on the opposite back side and/or front side, wherein the ridge/ridges is/are made in one piece with the blade body in question and serves/serve as a spacer means to prevent the cutting elements with their overhangs to hit each other during rotation of the blades.

According to the invention by providing the cutting elements with a first and a second overhang, grinding of the cutting elements is made a lot easier and thus producing too, because all contact between the sheet material of a blade body and a grinding disc used for grinding is easy to avoid. In addition, the overhangs contribute to breaking of chips, that penetrate between two cutting elements meeting each other, in a free space, which is formed by the overhang in question immediately behind the cutting element as to the sense of rotation, thus preventing the formation of long chips, which tend to get stuck between the saw blades. The ridge/ridges, which is/are easily made by turning or milling of the blade body/bodies before the cutting the cutting elements are attached, have no interruptions, which reduces operational noise and prevents operating interruptions because of chips that during operation enter into the space between the blades. Further, such a ridge/ridges is/are very durable and can withstand high working temperatures that occur during sawing.

Preferably a ridge is formed only on one of the blade bodies, said ridge having a height that exceeds the total height of said first and second overhang. This is advantageous mainly from an industrial engineering point of view, since it means that only one of the saw blades needs to be turned or milled.

According to a preferred embodiment, the cutting elements besides said first and second overhang on the sides facing each other have overhangs on their opposite sides too. Of course the latter overhangs also facilitate the milling of the cutting elements and further they contribute to a reduction of the friction of the blade bodies against the cut material.

### BRIEF DESCRIPTION OF THE DRAWINGS

A preferred embodiment of the invention is described in more detail in below with reference to the attached schematic drawings, in which:

FIG. 1 is a partial section view of a pair of saw blades according to the invention;

FIG. 2 is a partial section view along line II-II in FIG. 4 of the first blade of said pair;

FIG. 3 is a partial section view along line III-III in FIG. 5 of the second blade of said pair;

FIG. 4 is an overhead view of the front side of the first blade; and

FIG. 5 is an overhead view of the front side of the second blade.

### DESCRIPTION OF A PREFERRED EMBODIMENT

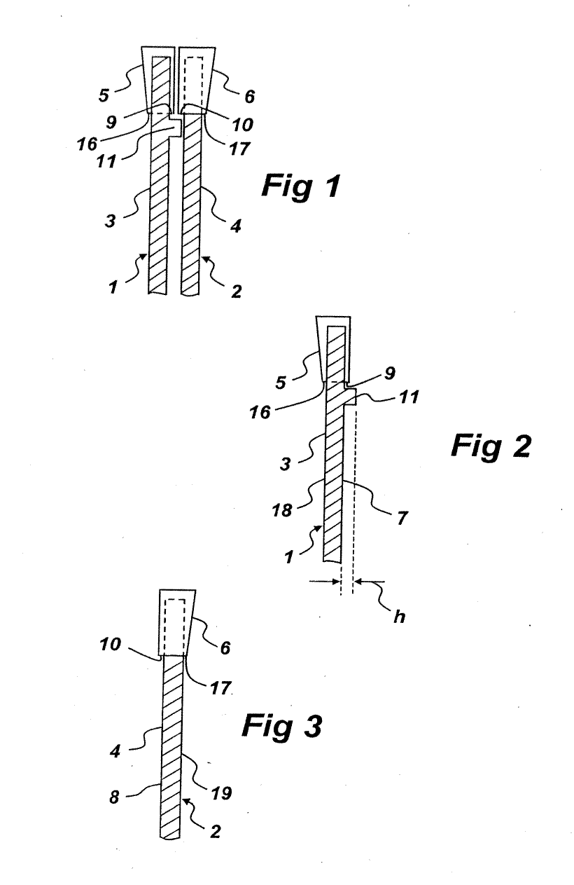

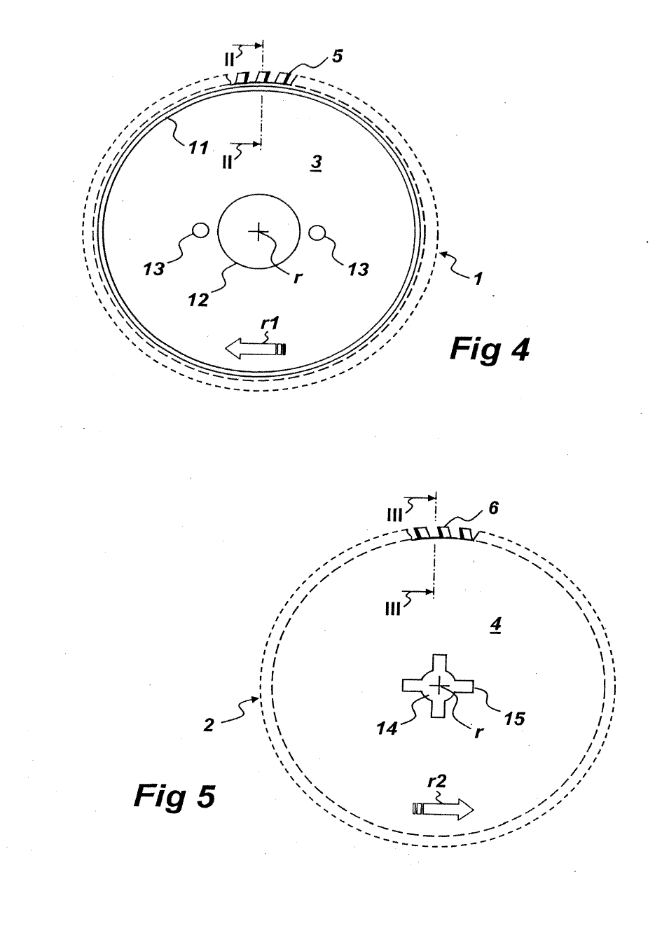

In FIG. 1 a pair of saw blades is shown, that consists of a first blade 1, which is arranged to rotate around a rotational axis r according to FIG. 4 in a first direction r1, and a second blade 2, which according to FIG. 5 rotates in a second direction r2, opposite to said first direction r1. Such an opposite rotation of the blades 1, 2 does effectively counteract all tendencies of throw and in addition it enables very high work rates.

Each blade 1, 2 has its o blade body 3, 4, which appropriately is made of sheet steel. Each blade body 3,4 has cutting elements along the periphery thereof, which in the embodiment shown are saw teeth 5, 6 with cutting edges of hard metal brazed thereon.

The saw teeth 5, 6 have, which is best shown in FIGS. 2 and 3, a slightly larger width than the associated blade body 3, 4. This means that the saw teeth 5 of the first blade 1 protrudes with a certain overhang 9 from the front side 7 of the blade 1, that is the side that is intended to be turned towards the second blade 2, and that saw teeth 6 of the second blade 2 protrudes with a certain overhang 10 from the back side 8 of the blade 2, that is the side that is intended to be turned towards the first blade 1.

In order to enable said rotation in opposite directions r1 and r2 despite the overhang without the saw teeth 5, 6 hitting each other, when the blades 1, 2 for sawing are mounted on and driven by a cutting tool, a spacer means is provided on the blade body 3 of the first blade 1. According to the invention this spacer means is an integral part of the blade body 3 and comprises of a annular ridge 11 (FIG. 4), which is concentric with the rotational axis r. The ridge 11 is made by turning the blade body 3 down both inside and outside of the ridge 11 and has a height h (FIG. 2) that slightly exceeds the combined heights of both of said overhangs 9, 10. The ridge 11 is all flat and unbroken and intended to slide over a corresponding flat part of the blade body 4 of the second blade 2. The flat and unbroken contact between the blades 1, 2 causes little friction and low noise, and in addition it effectively prevents particles, such as sawdust, from entering into the space between the blades 1, 2 during sawing.

According to the preferred embodiment of the invention, the pair of saw blades besides the ridge 11 also has a specially shaped central parts.

The first blade 1 has in its center a circular centering hole 12, which on both sides has drive peg notches 13 which are intended for corresponding drive pegs on a machine hub (not shown).

The second blade 2 too has in its center a centering hole 14. This is bordered by four drive peg notches 15 symmetrically arranged around the rotational axis r in the form of spoke wise slots, which extend from the centering hole 14. The angle between the slots 15 is 90°. The slots 15 are intended to cooperate in a stable way with a machine hub (not shown), which for said stable cooperation with the slots 15 has a central driver.

Currently the pair of saw blades shown in the drawings constitutes the preferred embodiment of the intention, but it should not be considered to be the only possible one. In particular, the central parts of the blades 1, 2 can be shaped in another way if another type of blade mounting is desired. In addition it is obvious that the ridge 11 instead could be provided on the second blade 2 or that a ridge 11 could be provided on each of the blades 1, 2.

Finally it is also obvious that the saw teeth 5, 6 described above made of hard metal could be cutting elements of another type, such as diamond bits, and that they, as shown, besides said first and second overhang 9, 10 on the sides 7, 8 of the blades 1, 2 facing each other, may have overhangs 16, 17 on their opposite sides 18, 19, said overhangs 16, 17 facilitating milling of the saw teeth 5, 6 and reducing friction of the blade bodies 3, 4 against a material cut with the saw blades 1, 2

1.-3. (canceled)

4. A pair of saw blades, comprising:
a first saw blade, which is arranged to rotate in a first direction around a rotational axis, and
a second saw blade, which is arranged to rotate around the same rotational axis in a second direction opposite to the first direction,
wherein each of the first and second saw blades includes a blade body and cutting elements along a periphery of each blade body, the cutting elements being arranged to run close to and in parallel with each other during rotation of the saw blades,
wherein the blade body of the first saw blade has a front side, which is intended to be turned towards a back side of the blade body of the second saw blade,
wherein the cutting elements on the blade body of the first saw blade protrude with a first overhang from said front side in a direction towards the second saw blade,
wherein the cutting elements on the blade body of the second saw blade protrude with a second overhang from said back side in a direction towards the first saw blade,
wherein at least one of said front side of the first saw blade and said back side of the second saw blade has a circumferential ridge, which is arranged radially inside of the cutting elements with respect to the rotational axis and provided to slide over a corresponding part on the opposite front side of the first saw blade or a corresponding ridge on the opposite back side of the second saw blade, and
wherein the ridge on the at least one of said front side of the first saw blade and said back side of the second saw blade is made in one piece with the respective blade body corresponding as a spacer to prevent the cutting elements with the respective overhangs hitting each other during rotation of the saw blades.

5. The pair of saw blades according to claim 4, wherein said ridge is provided only on one of the blade bodies and has a height that exceeds a total height of said first overhang and said second overhang.

6. The pair of saw blades according to claim 4, wherein the cutting elements beside said first and second overhangs on the sides facing each other have overhangs on the opposite sides.

7. The pair of saw blades according to claim 4, wherein the ridge on the at least one of said front side of the first saw blade and said back side of the second saw blade is made by turning or milling the respective blade bodies.

8. The pair of saw blades according to claim 7, wherein the ridge is turned or milled before the cutting elements are attached.

9. The pair of saw blades according to claim 4, wherein the ridge is provided on the blade body of the first saw blade, the ridge being flat and configured to slide over a corresponding flat part of the blade body of the second saw blade.

10. The pair of saw blades according to claim 4, wherein the ridge radially extends around on at least one of the blade body of the first saw blade and the second saw blade.

11. The pair of saw blades according to claim 10, wherein the ridge extends radially around in a continuous manner.

12. The pair of saw blades according to claim 4, wherein the ridge is provided on each of the blade bodies of the first saw blade and the second saw blade.

13. The pair of saw blades according to claim 4, wherein the first saw blade includes circular holes situated about a circular centering hole.

14. The pair of saw blades according to claim 4, wherein the second saw blade includes notches at a circular centering hole.

15. The pair of saw blades according to claim 14, wherein the second saw blade includes four notches symmetrically arranged around the rotational axis in a form of a spoke-wise slot.

16. The pair of saw blades according to claim 15, wherein an angle between the slots is 90°.
